(19) United States
(12) Patent Application Publication
(10) Pub. No.: US 2025/0088801 A1
(43) Pub. Date: Mar. 13, 2025

(54) DETECTING CONSTRUCTION EQUIPMENT VIA MICROPHONE AUDIO

(71) Applicant: FTSQUARED Developments Ltd, Wetherby (GB)

(72) Inventors: Michael JOSEPH, Wetherby (GB); Liam HAYES, Wetherby (GB)

(21) Appl. No.: 18/826,310

(22) Filed: Sep. 6, 2024

(30) Foreign Application Priority Data
Sep. 8, 2023 (EP) 23196394.3

(51) Int. Cl. H04R 5/027; G10L 25/27; G10L 25/51

(52) U.S. Cl. CPC H04R 5/027; G10L 25/27; G10L 25/51

(57) ABSTRACT

A system (100), method (300), and computer software (408) are described. The system (100) comprises microphones (202) distributed around a construction site (1), the system (100) comprising means for: receiving (302) audio information obtained by at least a first microphone of the microphones (202); and determining (308) a type of construction equipment (3) in-use based on the received audio information, via a machine learning engine.

### CROSS-REFERENCE TO RELATED APPLICATIONS

This application claims priority to European Patent Application No. 23196394.3, filed Sep. 8, 2023, the entire contents of which are incorporated herein by reference.

### TECHNOLOGICAL FIELD

Embodiments of the present disclosure relate to an apparatus, a method, and computer software, for detecting construction equipment via microphone audio.

### BACKGROUND

Construction sites are carefully controlled environments. In order to ensure that proper working procedures are followed, various processes and policies are implemented such as requirements about when and where various types of construction equipment can be used, and what processes workers should follow in proximity to the construction equipment. It is traditionally the role of site supervisors to enforce compliance with these processes. However, site supervisors cannot monitor all parts of the site at all times.

Technological solutions for automatically monitoring site activity and compliance with processes are advantageous. Closed circuit television (CCTV) systems enable manual remote monitoring. Automatic remote monitoring solutions are available, such as machine vision systems for monitoring whether staff are wearing hardhats. However, complete coverage of a site can be difficult due to CCTV blackspots, an absence of power outlets to power monitoring equipment, and the issue of workers removing or deactivating body-worn devices.

### BRIEF SUMMARY

According to various, but not necessarily all, embodiments of the invention there is provided a system comprising microphones distributed around a construction site, the system comprising means for:
receiving audio information obtained by at least a first microphone of the microphones; and
determining a type of construction equipment in-use based on the received audio information, via a machine learning engine.

The microphones may comprise omnidirectional microphones.

The system may comprise devices distributed around the construction site, each device comprising a different one of the microphones. Each device may be an edge device comprising the means for determining the type of construction equipment in-use, including a trained copy of the machine learning engine. Each device may comprise a battery, and wherein each trained copy of the machine learning engine represents weights and activations with a precision less than 32 bits, or less than 16 bits.

The devices may comprise securing means enabling attachment of the devices to supports.

The system may comprise means for:
obtaining information indicating a location of a first device of the devices, the first device comprising the first microphone; and
associating the determined type of construction equipment in-use with the information indicating the location of the first device.

The system may comprise means for causing, at least in part, outputting of an alert in dependence on the determined type of construction equipment in-use and on the information indicating the location of the first device.

The system may comprise means for filtering the audio information based on an intensity of the audio information, and determining the type of construction equipment in-use based on the filtered audio information.

The system may comprise means for generating samples of the audio information, the samples having a duration selected from the range 0.5 seconds to five seconds, and wherein determining the type of construction equipment in-use comprises processing at least one of the samples via the machine learning engine.

Determining the type of construction equipment in-use via the machine learning engine may be dependent on a first above-threshold frequency and on whether the audio information contains one or more further above-threshold frequencies which are simultaneous with the first frequency over a period of time.

The determination of a type of construction equipment in-use may be dependent on frequency content from the range 1.5 kHz to 8 KHz.

The determination of a type of construction equipment in-use may be based on two or more of the following variables: whether the audio information contains two simultaneous frequency bands; whether the audio information contains three simultaneous frequency bands; a centre frequency of at least one frequency band; a bandwidth of at least one frequency band; or an intensity of at least part of the audio information.

The machine learning engine may be trained to recognise, based on the two or more of the variables, at least two of the following types of construction equipment: angle grinder; saw; router; drill; vacuum cleaner; scaffold wrench; screw gun; pad sander; grinder; electric plane; or grinding wheel.

The system may comprise human presence detectors distributed around the construction site. The system may comprise means for causing, at least in part, outputting of an alert in dependence on the determined type of construction equipment in-use, and on information from the human presence detectors indicating an above-threshold number of humans proximal to the first microphone.

The system may comprise means for causing, at least in part, outputting of an alert in dependence on the determined type of construction equipment in-use and on time of day.

The system may comprise means for causing, at least in part, outputting of an alert in dependence on the determined type of construction equipment in-use and on a noise threshold.

The system may comprise means for sending an indication of the determined type of construction equipment in-use to a server.

The system may comprise means for causing, at least in part, outputting of an alert in dependence on the determined type of construction equipment in-use.

According to various, but not necessarily all, embodiments of the invention there is provided a method comprising:
receiving audio information obtained by at least a first microphone of a plurality of microphones distributed around a construction site; and
determining a type of construction equipment in-use based on the received audio information, via a machine learning engine.

According to various, but not necessarily all, embodiments of the invention there is provided an apparatus comprising means for:
receiving audio information obtained by at least a first microphone of a plurality of microphones distributed around a construction site; and
determining a type of construction equipment in-use based on the received audio information, via a machine learning engine.

According to various, but not necessarily all, embodiments of the invention there is provided computer software that, when executed, causes:
receiving audio information obtained by at least a first microphone of a plurality of microphones distributed around a construction site; and
determining a type of construction equipment in-use based on the received audio information, via a machine learning engine.

### BRIEF DESCRIPTION

Some examples will now be described with reference to the accompanying drawings in which:

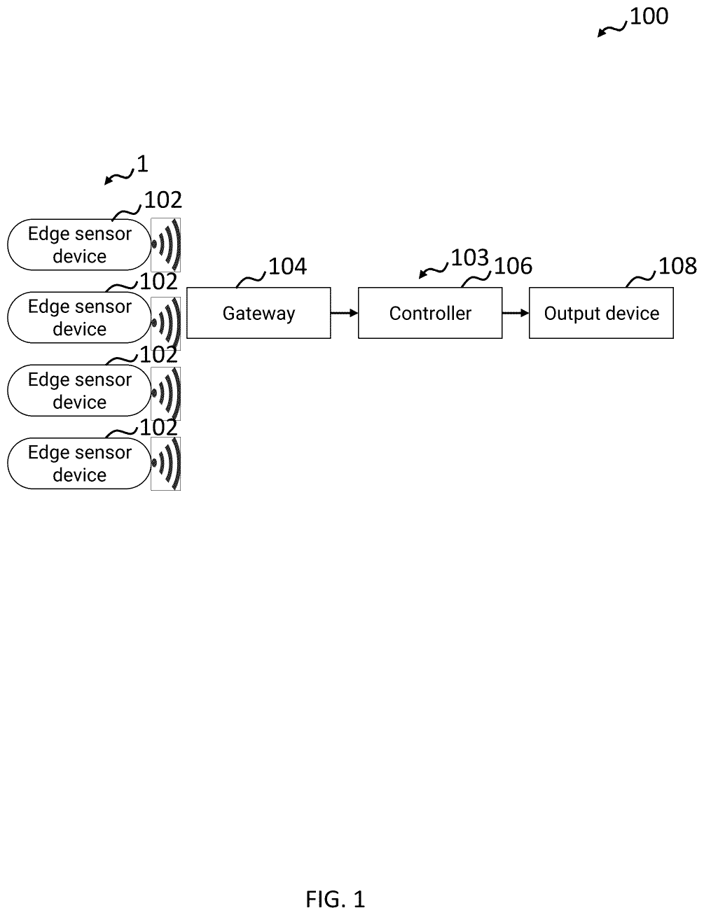

FIG. 1 illustrates an example of a system;

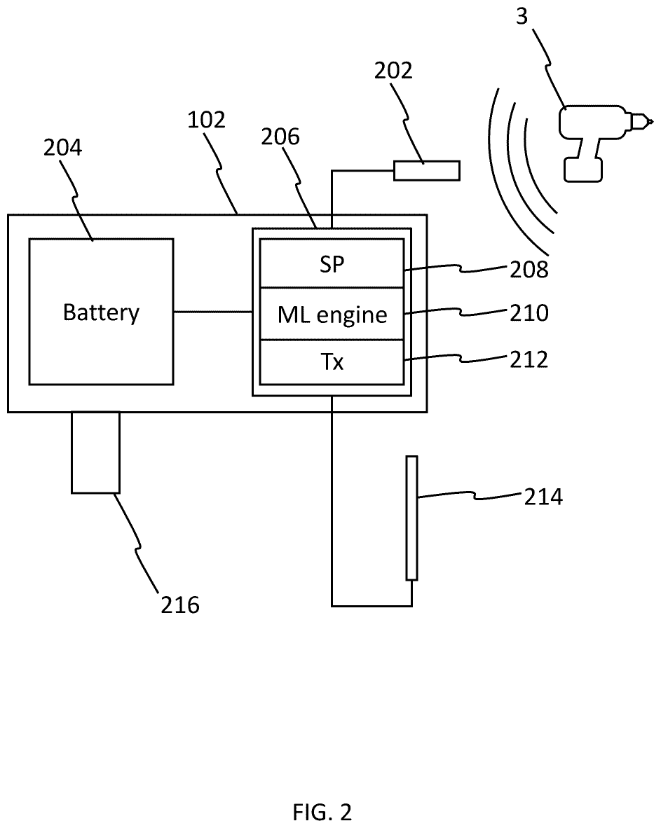

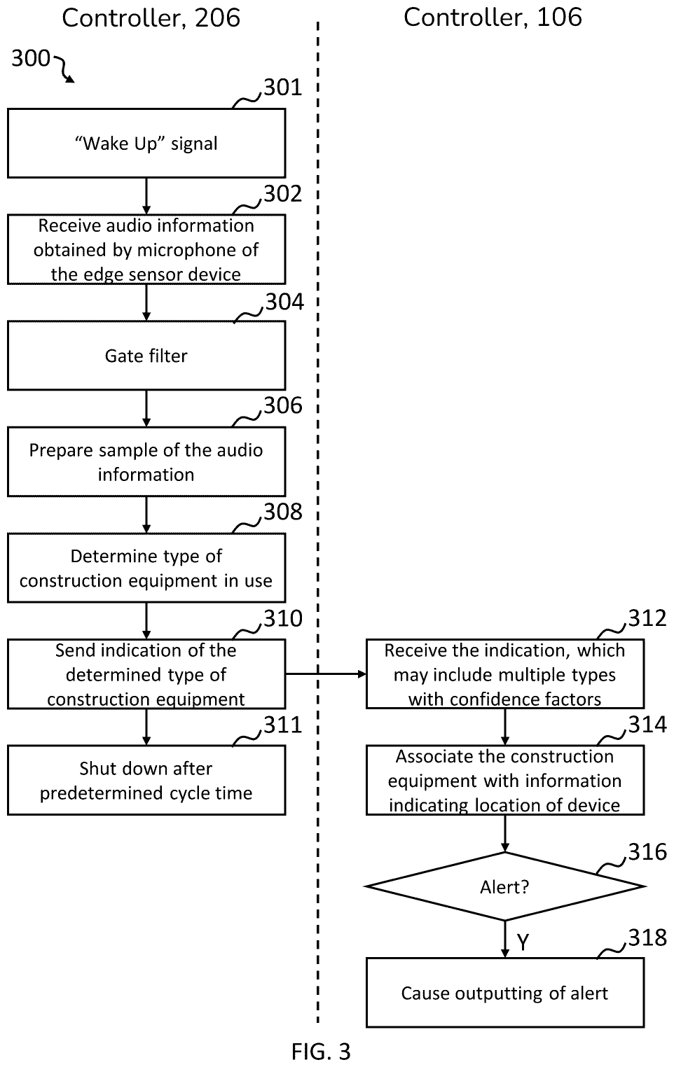

FIG. 2 illustrates an example of an edge sensor device;

FIG. 3 illustrates an example of a method;

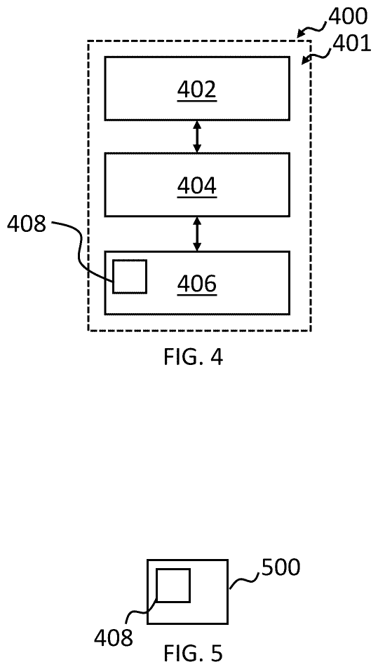

FIG. 4 illustrates an example of an apparatus;

FIG. 5 illustrates an example of a non-transitory computer-readable storage medium; and

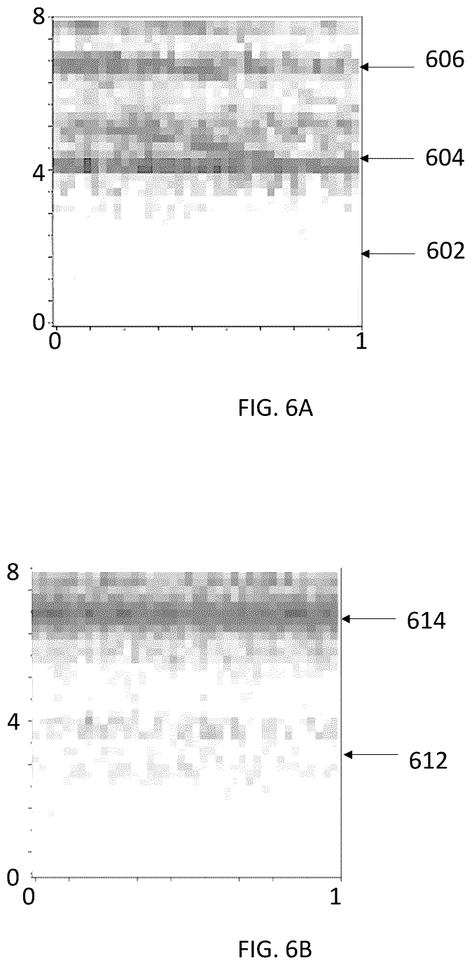

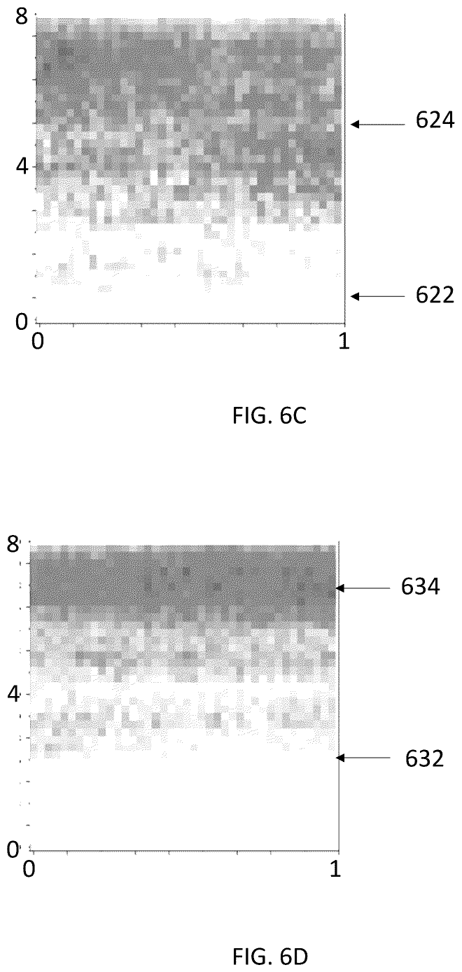

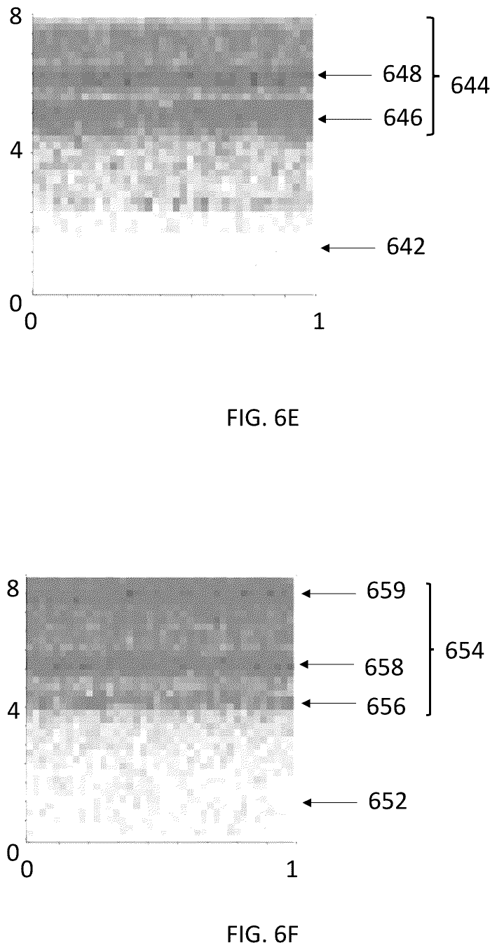

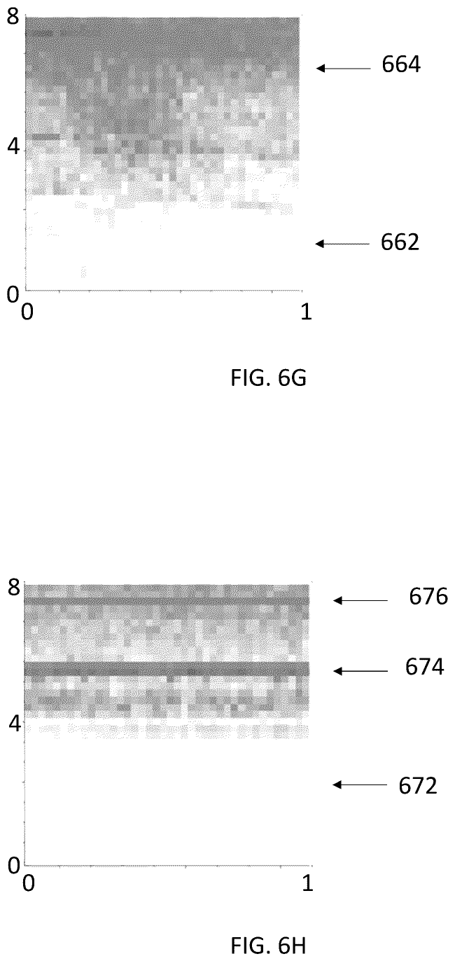

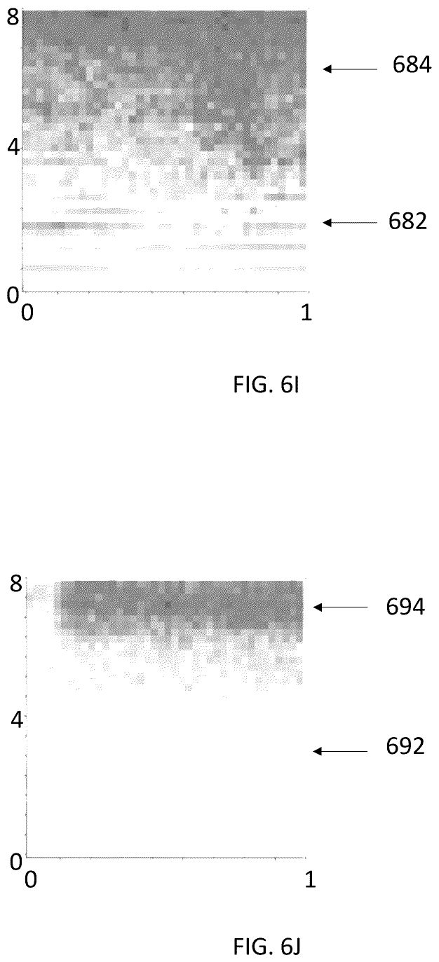

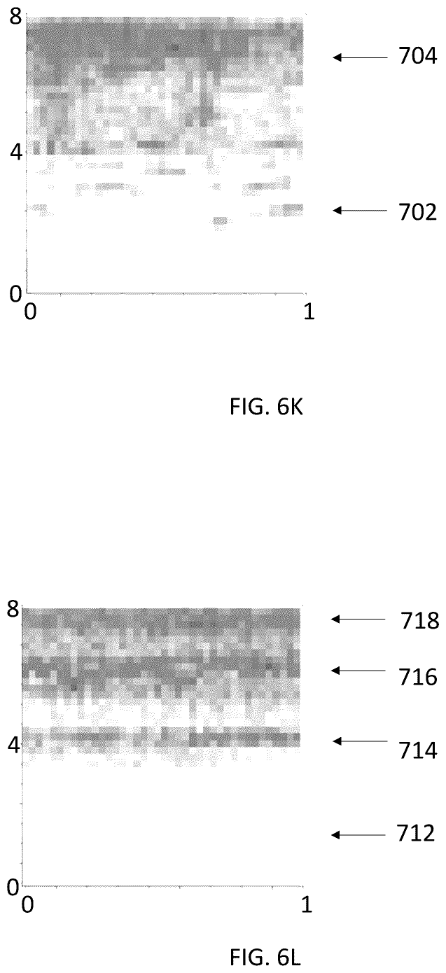

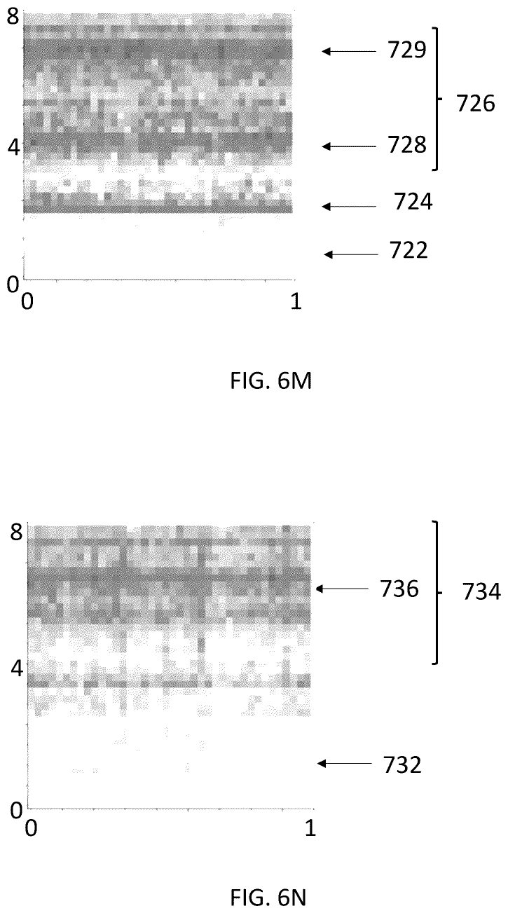

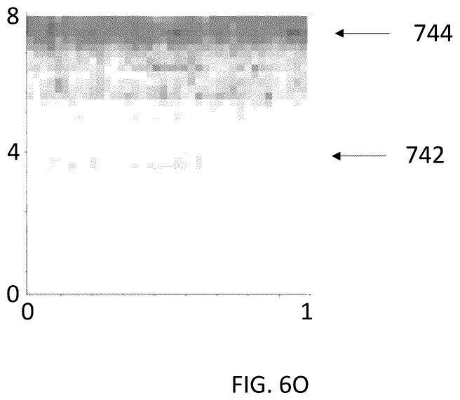

FIGS. 6A-6O illustrate spectrograms of different construction equipment for validating a machine learning engine.

### DETAILED DESCRIPTION

FIG. 1 illustrates a non-limiting example of a system 100 for a construction site 1, also referred to as a construction site system 100. The system 100 comprises an on-site sensor network of edge sensor devices 102, each comprising a microphone 202 as shown in FIG. 2. Each microphone 202 captures audio information within a detection range of the microphone 202. The edge sensor devices 102 may be low-power devices having an onboard battery 204 (electrical energy storage means). The battery 204 is useful as a construction site 1 may lack electrical power receptacles.

If construction equipment 3 (FIG. 2), such as a drill, saw, or grinder, is in-use in the detection range of one of the microphones 202, the edge sensor device 102 having that microphone 202 will locally determine the type of construction equipment 3 that is in-use. Definitions of types of construction equipment 3 are provided later in this description.

The edge sensor device 102 comprises a machine learning engine 210 (FIG. 2) configured to determine the type of construction equipment 3 in-use. Since the detection is carried out on-site by the edge sensor device 102, the system 100 can be regarded as an edge computing system where the data processing is performed at the sensor devices 102 (hence the term ‘edge sensor device’).

The machine learning engine 210 comprises any appropriate hardware, software, or a combination thereof, implementing a trained machine learning circuit or algorithm such an artificial neural network.

The machine learning engine 210 is trained to recognise a plurality of types of construction equipment 3 based on the audio information.

The machine learning engine 210 may be an offline-trained/pre-trained machine learning engine, to minimise power requirements and prolong battery life of the edge sensor devices 102.

If the machine learning engine 210 was trained by supervised or semi-supervised learning, a “type” of construction equipment 3 can refer to a class corresponding to a class label input in training. If the machine learning engine 210 was trained by unsupervised learning, a “type” may refer to an unlabelled group or cluster.

In response to determining the type of construction equipment 3 in-use, the edge sensor device 102 sends to a server controller 106 an indication of the determined type of construction equipment 3 in-use. The indication may be sent via any appropriate reporting message.

Determining the type of construction equipment 3 in-use can comprise the machine learning engine 210 probabilistically recognising the type of construction equipment 3 in-use.

Probabilistic recognition can comprise a confidence score determined by the machine learning engine 210 being above a confidence threshold. The sending of the indication may be initiated by one of a plurality of confidence scores being above a threshold, where each confidence score corresponds to a different predetermined type of construction equipment 3.

The sending of the indication to the server may be triggered in response to the exceedance of the confidence threshold. Each edge sensor device 102 may be configured to send the indication in real-time in response to the exceedance of the threshold (e.g., within <1 minute of initiation of actual use of the type of construction equipment 3).

The sent indication may identify the type of construction equipment 3 having the highest confidence score. In some examples, the indication may further indicate the confidence scores of the other types of construction equipment 3. Therefore, the sent indication may comprise a plurality of confidence scores for each of a plurality of types of construction equipment 3.

In an environment where battery power is being relied on, it may be necessary to reduce energy consumption by using intermittent sampling. The duration ‘X’ of a sampling period may be shorter than the time interval ‘Y’ between sampling periods. For example, X<0.9Y, or X<0.5Y, or X<one minute and Y>five minutes.

A sampling period may be a sampling aggregation period in which a plurality of samples are collected and analysed to determine a plurality of indications. Within a sampling aggregation period, Z samples may be collected where X>2Z, or X>5Z, or X>10Z.

In an example implementation, a sampling aggregation period is X=30 seconds, each sample is Z=1 second, and results in 15×1 second samples. This can result in multiple unique indications in that sample period. The time interval between sampling aggregation periods is Y=10 minutes.

A message may be sent to the server in response to completion of at least one sampling aggregation period. The message may therefore contain a plurality of unique indications of types of construction equipment. The intermittent sending of messages reduces energy consumption.

The sending of the indication can further comprise sending information indicating a location of the edge sensor device 102, such as geographical coordinate information (e.g., Global Positioning System, GPS), or the device identity of the edge sensor device 102. The controller 106 may be configured to automatically associate the device identity with a location, for example where the controller 106 looks up the location based on a stored data structure (e.g., database) associating each device identity to a different location in the construction site 1. Alternatively, the locations of each device identity may be known to a human operator.

In-use, individual edge sensor devices 102 may be distributed around the construction site 1 in one or more of the following ways: on different building floors; in different rooms; in different buildings; in different outdoor areas. The database, if provided, may associate the different edge sensor devices 102 with the different floors, rooms, buildings, and/or outdoor areas.

Upon receiving the indication of a type of construction equipment 3 in-use from an edge sensor device 102, the controller 106 can be operably coupled to an output device 108 shown in FIG. 1. The output device 108 may comprise a device suitable for rendering alerts in dependence on the indication. Examples include loudspeakers, electronic displays, haptic feedback devices, or a combination thereof. The controller 106 may be configured to control the output device 108 in dependence on at least the indication. Examples of specific alerts are described later in this description.

In some examples, the controller 106 may store the indication in a memory of the controller 106, and/or send the indication for storage in remote memory.

The controller 106 may be embodied in a server apparatus 103. The controller 106 may be remote, and located outside the construction site 1. If remote, the controller 106 can either be distributed (e.g., cloud-based) or centralised. Alternatively, the controller 106 may be a local server controller located in the construction site 1. The output device 108 may be inside or outside the construction site 1.

FIG. 1 illustrates that the controller 106 is wirelessly connected to the edge sensor devices 102 via a gateway 104. The gateway 104 may be in the form of a wireless gateway. The gateway 104 may be located in the construction site 1. FIG. 1 illustrates that the gateway 104 may be connected to a plurality of the edge sensor devices 102. Four edge sensor devices 102 are shown. In practice, any number of edge sensor devices 102 may be employed. Any number of gateways 104 may be employed.

The presence of an on-site gateway 104 obviates the need for long-range communication circuitry in the edge sensor devices 102, and enables low power transmitter/transceiver antennas 214 to be used in the edge sensor devices 102. Therefore, battery life is prolonged. Alternatively, the edge sensor devices 102 may be provided with other appropriate communication interfaces that enables the gateway 104 to be omitted, for example, wired, cellular, or satellite communications circuitry.

In sites that are not power-constrained or bandwidth-constrained, determining the type of construction equipment may be performed off-board from the edge sensor device 102, for example at server end. This increases the data transmission overheads because the samples are transmitted rather than the indications.

The gateway 104 can comprise one or more receiver antennas wirelessly coupled to transmitter antennas 214 of the edge sensor devices 102. In some examples, two-way communication is possible such that each edge sensor device 102 comprises a transceiver antenna 214, and the gateway 104 comprises a transceiver antenna.

In a further alternative example, the client-server topology is omitted such that each edge sensor device 102 can individually control the output device 108. In this example, each edge sensor device 102 has the functionality of the controller 106.

FIG. 2 schematically illustrates the components of each edge sensor device 102.

Each edge sensor device 102 comprises a housing containing electronic components. In an implementation, an edge sensor device 102 is a static device rather than a hand-portable or body-worn device. Therefore, the housing can comprise securing means 216 (securing points), such as a bracket or mechanical fixing points, or a magnetic attachment point, enabling attachment of the edge sensor device 102 to a support.

The edge sensor device 102 can be battery-powered. Therefore, a battery 204 is shown in FIG. 2.

The edge sensor device 102 comprises a microphone 202. Although the illustrated microphone 202 is outside the housing, it could alternatively be inside the housing behind an open aperture of the housing.

The detection range of the microphone 202, and therefore of each edge sensor device 102, may be in the order of metres to tens of metres.

The microphone 202 can be omnidirectional meaning that it has an omnidirectional polar pattern. A polar pattern can be considered omnidirectional when it captures sound from all directions with a minimum gain direction being within 10% of the maximum gain direction.

The edge sensor device 102 comprises a controller 206. The controller 206 comprises a signal processor 208, a machine learning engine 210, and an output transmitter circuit 212. These can be implemented as hardware, software, or a combination thereof.

The signal processor 208 can be a preprocessor between the microphone 202 and the machine learning engine 210. The signal processor 208 can be a digital signal processor, for example.

In some examples, the signal processor 208 comprises an analog to digital converter to sample the audio information.

The signal processor 208 can be configured with a gate filter for filtering the audio information based on a sound intensity of the audio information (e.g., gain, SINR). Determining the type of construction equipment in-use is based on the filtered audio information.

The gate filter is for filtering out portions of the audio information that should not be used to determine the type of construction equipment 3 in-use.

A gate filter can attenuate audio information having a sound intensity below a threshold, within a sample.

The gate filter may be implemented in the signal processor 208.

The value of the threshold of the filter effectively configures the detection range of the edge sensor device 102, because the inverse square decay of sound intensity increases with distance to the noise source.

Therefore, different edge sensor devices 102 may be configured with different effective detection ranges (thresholds of the filter) to suit the particular construction site and their distribution around the construction site.

The signal processor 208 may comprise a filter having a passband that includes the range 1.5 kHz to 8 kHz, because the highest quality information discriminating between different types of construction equipment 3 is within this range. Therefore, the machine learning engine 210 may receive filtered audio information, or filtered and gated audio information. The filter may comprise a band pass filter or a high pass filter. The removal of frequencies outside this band can be desirable for a construction site 1 due to the nature of the equipment to be detected. In some examples, the signal processor 208 comprises a plurality of the filters. The machine learning engine 210 may have been trained based on the filtered audio information to learn the activation thresholds for each band.

The signal processor 208 may prepare fixed-length or variable-length samples of the audio information. In some, but not necessarily all examples, the sample generator may be configured to prepare samples of a duration selected from the range 0.5 seconds to five seconds.

During training of the machine learning engine 210, short fixed-length samples were found to provide good results. Where the machine learning engine 210 may be trained based on steady-state use of the construction equipment 3, samples over a longer duration could introduce variations such as the speed or on/off cycling of the construction equipment 3.

The machine learning engine 210 in FIG. 2 is configured to determine the type of construction equipment 3 in-use based on the audio information processed by the signal processor 208, and a confidence score of the determination. The determined type of construction equipment 3 along with a confidence score is then sent to the output transmitter circuit 212 to cause sending of the indication of the determined type of construction equipment 3 in-use. The output transmitter circuit 212 can be coupled to a transmitter/transceiver antenna 214, in examples.

In some examples, the machine learning engine 210 may be unimodal, meaning that the machine learning engine 210 takes into account only one modality of information: the audio information. Alternatively, the machine learning engine 210 may take into account audio metadata (e.g., time of capture) as another information modality. The machine learning engine 210 may be non-image based, not depending on video or image information modalities.

Example implementations of the machine learning engine 210 are now described. For the purposes of being able to run the trained machine learning engine 210 on a small microprocessor controller 206, Tensorflow Lite™ may be used.

TensorFlow Lite is a lightweight version of TensorFlow, an open-source machine learning framework. TensorFlow Lite 32 is a specific version of the TensorFlow Lite library that is optimised for running on devices with 32-bit processors. The controller 206 may comprise a 32-bit processor. TensorFlow Lite 32 is designed to allow developers to easily deploy machine learning models on a wide range of devices, including IoT devices such as we will use without the need for powerful hardware.

TensorFlow Lite 32 includes a number of performance enhancements and optimizations for running on resource-constrained devices, and supports a variety of neural network architectures and operations. Additionally, the machine learning engine 210 may utilise TensorFlow Lite int8 post processing.

TensorFlow Lite int8 quantized models are a type of TensorFlow Lite model that uses 8-bit integers (int8) to represent the weights and activations of the neural network, rather than the 32-bit floating-point numbers (float32) used in standard models. This allows for a significant reduction in the model size and memory requirements while maintaining a good level of accuracy. The quantization process involves mapping the continuous floating-point values in the model to a fixed set of discrete values that can be represented using fewer bits. The quantization process can be done during the training process or after the model is trained.

The TensorFlow Lite int8 quantization process is based on a technique called quantization-aware training. In this method, the model is trained with quantization-aware operations that simulate the quantization process during training. This allows the model to adapt to the quantization process and maintain a high level of accuracy. The quantized model is then deployed on the target device, where it uses 8-bit integers to represent the weights and activations, reducing the memory requirements and computational complexity.

In addition to the size and memory benefits, TensorFlow Lite int8 quantized models also offer improved performance on some devices, as the smaller integer values can be processed more efficiently by the CPU or GPU. However, this may come at a cost of slightly reduced accuracy, especially on models that are already highly accurate.

Regarding the extensiveness of the training dataset, the machine learning engine 210 may be trained to recognise the sounds produced by a wide variety of types of construction equipment 3. In this context, the term “construction equipment 3” is understood to refer to the types of electrical tools used in the construction industry, for example for the construction of buildings and infrastructure.

In some examples, the machine learning engine 210 is trained to recognise a plurality of types of active (electrically-powered) construction equipment 3 including two or more from the following list: angle grinder; table saw; router; drill; vacuum cleaner; drill press; hammer drill; plasterboard screw gun; pad sander; grinder electric plane; or grinding wheel.

In some examples, the machine learning engine 210 is trained to recognise one or more types of passive construction equipment 3 such as hammers or ratcheting tools such as scaffold wrenches.

The machine learning engine 210 may be trained to recognise at least one type of equipment for at least one of the following applications:

TABLE 1

| | |
|---|---|
| Metalworking tools | Angle grinder, Steel saw, Table saw, Jigsaw, |
| | Bench Grinder, Angle Grinder, Battery drill, Drill |
| | press, Grinding wheel |
| Woodworking tools | Angle grinder, Steel saw, Table saw, Jigsaw, |
| | Screw gun, Router, Pad sander, Bench |
| | Grinder, Electric plane, Battery drill, Drill press, |
| | Grinding wheel |
| Composite material | Angle grinder, Hammer drill, Steel saw, Table |
| tools (e.g., | saw, Jigsaw, Bench Grinder, Battery drill, Drill |
| concrete, masonry) | press, Grinding wheel |
| Plasterwork tools | Angle grinder, Steel saw, Table saw, Jigsaw, |
| | Screw gun, Router, Pad sander, Bench |
| | Grinder, Electric plane, Battery drill, Drill press, |
| | Grinding wheel |
| Other tools | Vacuum, Scaffold wrench |

The machine learning engine 210 may be trained to recognise more than one of the types of metalworking tools. The machine learning engine 210 may be trained to recognise more than one of the types of woodworking tools. The machine learning engine 210 may be trained to recognise more than one of the types of composite material tools. The machine learning engine 210 may be trained to recognise more than one of the types of plasterwork tools. The machine learning engine 210 may be trained to recognise tools from more than one of the applications in the left column of Table 1.

Where the same type of construction equipment 3 is usable in multiple applications (types of materials), the machine learning engine 210 may be trained to differentiate between the applications based on the different sound produced when the construction equipment 3 is used on the different materials.

The machine learning engine 210 may be trained to recognise at least one type of equipment for at least one of the following types of tool motion:

TABLE 2

| | |
|---|---|
| Driving | Hammer drill, Screw gun, Battery drill, |
| | Drill press |
| Sawing | Angle grinder, Hand saw, Table saw, |
| | Jigsaw, Router, Electric plane, Grinding |
| | wheel |
| Surface | Pad sander, Grinder, Electric plane, |
| finishing/tangential | Grinding wheel |

The machine learning engine 210 may be trained to recognise more than one of the types of driving tools. The machine learning engine 210 may be trained to recognise more than one of the types of sawing tools. The machine learning engine 210 may be trained to recognise more than one of the types of surface finishing tools. The machine learning engine 210 may be trained to recognise tools from more than one of the motions in the left column of Table 2.

FIG. 3 is a flowchart illustrating an example method 300 representing a sampling period and the sending of a message to a controller 106 (e.g., server). The method 300 is implemented by one or more controllers 206, 106.

If the system 100 is as shown in FIG. 1, then FIG. 3 illustrates an example of which blocks may be executed locally by the controller 206 of the edge sensor device 102, and which blocks may be executed remotely by the controller 106. However, it would be appreciated that any of the blocks can be performed by any number of controllers.

At block 301, the controller 206 of the edge sensor device 102 sends a ‘wake-up’ signal to the signal processor 208, to initiate a sampling period. The wake-up signal may be triggered by a timer, or in dependence on an above-threshold sound intensity, or the like.

At block 302, the controller 206 of the edge sensor device 102 receives the audio information obtained by the microphone 202 of the edge sensor device 102. The audio information may be processed audio information as processed by the signal processor 208. For example, the audio information may be sampled to a fixed length, and/or filtered and/or gated.

At decision block 304, the controller 206 of the edge sensor device 102 applies the earlier-described gate filter.

The method 300 proceeds to block 306. At block 306, the controller 206 of the edge sensor device 102 prepares at least one of the earlier-described samples of the audio information. Samples within the sampling period may be substantially contiguous, within the sampling period. Specifically, this may be implemented by the signal processor 208. Additionally, or alternatively, the audio information may be filtered as described earlier.

At block 308, the machine learning engine 210 of the controller 206 of the edge sensor device 102 determines the type of construction equipment 3 in-use, based on the audio information processed at block 306. The prepared sample may be analysed at block 308, and then method 300 may loop back to cause block 306 to prepare the next sample until the awake window (predetermined cycle time) has expired.

At block 310, the controller 206 of the edge sensor device 102 causes the output transmitter circuit 212 to send the indication of the determined type of construction equipment 3 in-use to the controller 106, such as a server controller. The indication may be as described earlier, such as a message.

If the construction equipment 3 in-use cannot be determined (e.g., confidence scores below threshold or no audio signal detected), the controller 206 of the edge sensor device 102 may not send the indication to the controller 106. In other words, the sending of messages based on construction equipment 3 can be conditional rather than continuous. Therefore, battery power is saved as there is no need to continuously stream data wirelessly.

The audio information itself may not be transmitted from the edge sensor device 102 to the controller 106 or any other external device. The audio information may be deleted automatically (without user intervention) by the controller 206 of the edge sensor device 102 after the construction equipment 3 has been determined at block 308. By not transmitting the audio information, energy usage is further reduced because only a small amount of data is required to indicate a type of construction equipment 3, relative to transmitting audio information. This also improves security and privacy because any speech in the audio information would not be transmitted wirelessly.

If the condition is not satisfied, the method 300 instead proceeds to block 311 in which the controller 206 shuts down the signal processor 208 after a predetermined cycle time, to save energy. The predetermined cycle time may be in the order of minutes/hours. Blocks 308 and 310 are not performed. Therefore, the machine learning engine 210 may remain in an inactive state and no indication may be sent. Block 306 may not be performed, either.

The sending of the indication at block 310 may be performed in response to the machine learning engine 210 determining the type of construction equipment 3 in-use by reference to a threshold confidence score. In some examples, only one sample is sufficient to trigger the sending of the indication. In some examples, the controller 206 may require the same type of construction equipment 3 to be determined from a second sample collected within a predefined period. For example, two or more adjacent/contiguous samples of the audio information may need to agree in order to trigger the sending of the indication. This reduces false positives.

The remaining blocks 312-318 may be performed by the controller 106. However, some blocks may instead be performable locally by the controller 206.

At block 312, the controller 106 receives the indication sent at block 310. As described earlier, the controller 106 may receive the confidence scores of multiple types of construction equipment 3.

At block 314, the controller 106 associates the determined type of construction equipment 3 in-use with information indicating the location of the edge sensor device 102. The controller 106 may store the association in a memory. The storing of these associations may act as a log or tracker of which types of construction equipment 3 have been used. The locations and times of the uses may additionally be stored.

The controller 106 may obtain the information indicating the location of the edge sensor device 102 either from the edge sensor device 102 itself (e.g., geographical coordinate information), or via lookup. A lookup first comprises extracting device-identifying information from the message, such as a ‘device id’. The lookup then comprises inputting the device-identifying information into a search query to look up the location from a data structure (e.g., database) stored in memory. The data structure may store associations between different device-identifying information and different predetermined locations.

At decision block 316, the controller 106 determines whether to trigger the outputting of an alert by the output device 108. The decision block 316 is dependent at least on the determined type of construction equipment 3 in-use. If the decision is positive, the method 300 proceeds to block 318 which causes the output device 108 to output the alert.

If a sound is detected which is above the pre-processing threshold (gate filter threshold) but is repeatedly not identified to be a particular type of construction equipment 3, the controller 106 can cause outputting of an alert in response, indicating the possibility of additional sounds to be added to the training set for recognition in future.

If some types of construction equipment 3 must not be used in certain locations in the construction site 1, the decision block 316 can further depend on the information indicating the location of the edge sensor device 102.

If some types of construction equipment 3 must not be used at certain times of day, or certain days (weekends & holidays) the decision block 316 can further depend on a monitored time of day or day of the week, or calendar date.

If the sound of water is detected either as rain on a surface or as water flowing from a pipe etc, the decision block 316 can evaluate the recurrence of this indication. If confirmed, the method 300 proceeds to block 318 which causes the output device 108 to output the alert.

If some types of construction equipment 3 require ear protection to be worn, the decision block 316 can further depend on a measured sound intensity of the audio information along with frequency information. The resulting alert may be transmitted to an output device 108 advising personnel to wear ear protection. The output device 108 can range from a mobile equipment (ME) of a user or a site foreman, to a static display, or to a speaker/display integrated with the edge sensor device 102.

If some types of construction equipment 3 must not be used in the presence of an above-threshold number of humans proximal to the edge sensor device 102, the decision block 316 can further depend on information received by the controller 106 from one or more human presence detectors (not shown).

In an implementation, human presence detectors are configured to count the number of mobile equipment (ME) devices in their vicinities via any appropriate counting algorithm. ME devices are hand-portable mobile electronic devices such as mobile phones, smartphones, laptop computers, tablet computers, etc. Human presence detectors can comprise wireless radio frequency (RF) signal receivers and circuitry, collectively configured to operate as Wi-Fi™ counters and/or as Bluetooth™ counters. The receiver antennas may comprise any appropriate GHz-sensitive antennas connected to receiving circuitry. The receiver antennas may be configured to operate within at least part of the 2.4 GHz-5 GHz range.

A human presence detector may be implemented in at least some of the edge sensor devices 102, or may be implemented in separate devices.

Turning now to FIGS. 6A-6O, these figures show spectrograms of training data for training the machine learning engine 210.

Each spectrogram shows a tool audio signature for recordings of tools/construction equipment 3 used on a construction site 1.

FIGS. 6A-6O each represent a one second sample of data.

In the spectrograms, the X-axis represents time and the Y-axis represents increasing Frequency, linearly increasing from 0 Hz at origin to 8 kHz at the top of each spectrogram.

The dark area on the spectrograms represents the highest intensity (spectral density) of the audio signal, with more intense higher frequencies appearing at the top of the y-axis. The darker the shade, the higher the intensity. These distinctions in frequencies/intensity allow the machine learning engine 210 to identify specific tools being used.

Audio signatures of tools on a construction site 1 were recorded and augmented with samples from the Internet to create a library of 15 tool types with multiple recordings for training and testing a machine learning engine 210. Primary data was collected using a digital recording device on site 1, and the audio was then cut into usable segments. Internet videos of tools provided a secondary data source: appropriate videos were downloaded, the audio extracted, and then cut into 1-second segments for upload onto the training platform. The audio recordings were uploaded to a cloud-based machine learning platform, and analysed for distinct features. The machine learning platform implemented an CNN artificial neural network.

The training platform used was the ‘EdgeImpulse’™ platform.

A lightweight machine learning engine 210 was trained in this manner to recognise various sounds. The trained machine learning engine 210 can be deployed on a small microprocessor board of an edge sensor device 102, able to run on battery power and make edge-based machine learning inferences. The edge sensor device 102 can transmit results via narrow band wireless communication to a server controller 106, such as a cloud-based controller, for storage and further action.

The spectrograms are for a number of different tools and serve only to show that each tool has a distinctly different audio signature when analysed.

FIG. 6A illustrates the spectrogram for an angle grinder. An angle grinder is also known as a side grinder or disc grinder. An angle grinder is a handheld power tool used for grinding (abrasive cutting) and polishing via a high speed rotating metal disc. Angle grinders in this study were powered by an electric motor. Reference 602 illustrates that low intensity is found in the frequency range below 4 kHz. Reference 604 illustrates that a distinct band is present between 4 kHz to 4.25 kHz. Reference 606 illustrates that a second distinct band is present between 6.4 kHz to 6.8 kHz.

FIG. 6B illustrates the spectrogram for a hammer drill. A hammer drill is also known as a percussion drill or impact drill. It is a handheld power tool for drilling in hard materials such as concrete. It is a rotary drill with an impact mechanism to create a percussive hammering motion, for pulverising the material. Reference 612 illustrates that low intensity is found in the frequency range below 5.7 kHz. Reference 614 illustrates that a strong singular band is present from 6.3 kHz to 7.4 kHz.

FIG. 6C illustrates the spectrogram for a scaffold wrench. A scaffold wrench is a battery driven handheld power tool for securing clamps on a scaffolding structure. A scaffold wrench has a ratchet mechanism and a socket tool piece attached to its end. Reference 622 illustrates that low intensity is found in the frequency range below 2.5 kHz. Reference 624 illustrates a strong dispersed band present from 4 kHz to 7.4 kHz.

FIG. 6D illustrates the spectrogram for a steel saw. A steel saw is a power tool sometimes referred to as a chop saw but in our test data we have referred to this type of saw as it is fitted with a blade specific to steel cutting. A steel saw is used to cut through metal by placing a toothed edge of the blade against the material to be cut and pressing down. The steel saw sample is one used for cutting lengths of narrow gauge steel to be used in construction. Reference 632 illustrates that low intensity is found in the frequency range below 5.7 kHz. However, there are some dispersed sub-bands in this frequency range below 5.7 kHz.

Reference 634 illustrates that a strong band is present from 6.4 kHz to 7.8 kHz. The bandwidth of this band 634 is wider than that of the hammer drill of FIG. 6B.

FIG. 6E illustrates the spectrogram for a table saw. A table saw is a power tool also known as a sawbench or bench saw. A table saw has a circular saw blade, mounted on an electric motor-driven arbor. Part of the blade protrudes through a slot in the surface of a table, where the table is for supporting the material to be cut (usually wood). Cutting is achieved by sliding the material along the table, relative to the statically-mounted rotating saw. Reference 642 illustrates that low intensity is found in the frequency range below 2.3 kHz. Reference 644 illustrates a strong dispersed band present from 4 kHz to 8 kHz. Reference 646 illustrates a first sub-band from 4.5 kHz to 5.3 kHz. Reference 648 illustrates a second sub-band from 5.8 kHz to 6.2 kHz. The sub-bands 646, 648 are within the band 644.

FIG. 6F illustrates the spectrogram for a jigsaw. A jigsaw is a handheld power tool having a reciprocating elongated linear blade that moves in a reciprocating motion relative to the body of the tool. The blade can be used to cut irregular curves in wood, metal, or other materials. Reference 652 illustrates that low intensity is found in the frequency range below 4 kHz. Reference 654 illustrates a strong dispersed band present from 4 kHz to 8 kHz. Reference 656 illustrates a first sub-band from 4 kHz to 4.25 kHz. Reference 658 illustrates a second sub-band from 5 kHz to 5.5 kHz. Reference 659 illustrates a third sub-band from 7.2 kHz to 7.6 kHz. The sub-bands 656, 658, 659 are within the band 654.

FIG. 6G illustrates the spectrogram for a plasterboard screw gun. A screw gun is a handheld rotary power tool similar to a handheld drill, but is specifically for driving screws. A screw gun has a driven rotating nose having a screw bit attached, for engaging with and rotating a screw head. Reference 662 illustrates that low intensity is found in the frequency range below 2.5 kHz. Reference 664 illustrates a strong dispersed band from 4.5 kHz to 8 kHz. Unlike the plasterboard screw gun of FIG. 6C, the band 664 has more intensity at the higher frequencies towards 8 kHz.

FIG. 6H illustrates the spectrogram for a router. A router is a power tool with a flat base and a rotatable spindle-mounted blade extending past the base. This can be used to ‘rout’ (hollow out/cut channels in) a material such as wood or plastic. It is usually a handheld tool. Reference 672 illustrates that low intensity is found in the frequency range below 3.5 kHz. Reference 674 illustrates a strong band from 5.3 kHz to 5.7 kHz. Reference 676 illustrates a strong band at 7.4 kHz. These are higher frequency, narrower bands 674, 676 than the bands 604, 606 of the angle grinder of FIG. 6A.

FIG. 6I illustrates the spectrogram for a pad sander. A pad sander is a handheld power tool with an orbital drive and a sheet of sandpaper attached to its base. The pad sander translates the sheet in a direction tangential to the surface to sand the surface. Reference 682 illustrates that low intensity is found in the frequency range below 2.7 kHz. However, there are some distinct narrow sub-bands within this low frequency range. Reference 684 illustrates a dispersed high frequency signal from 5 kHz to 8 kHz.

FIG. 6J illustrates the spectrogram for a grinder. A grinder is a power tool with a rotating abrasive wheel attached to a body. The wheel has a surface having grains of abrasive material. A grinder can therefore be used to smooth a surface. The material to be ground may be brought into contact with the wheel to grind the surface of the material. Reference 692 illustrates that low intensity is found in the frequency range below 6.2 kHz. Reference 694 illustrates a strong band from 6.3 kHz to 7.8 kHz.

FIG. 6K illustrates the spectrogram for an electric plane (planer). An electric plane is a handheld power tool for shaving a surface of a material such as wood. An electric plane has a rotating blade between front and rear flat planar surfaces, wherein the blade is of adjustable height to control the shaving depth. The plane is moved along the surface of the material to shave the material. Reference 702 illustrates that low intensity is found in the frequency range below 4 kHz. Some faint narrow bands are visible from 2 kHz to 4 kHz. Reference 704 illustrates a dispersed strong signal from 5 kHz to 7.5 kHz, which is strongest from 6.5 kHz to 7.5 kHz. Another narrow band is also visible at around 4 kHz.

FIG. 6L illustrates the spectrogram for a battery drill, in this case a non-hammer drill. It has the features of a hammer drill except the impact mechanism. The power or speed may be lower due to being battery powered. Reference 712 illustrates that low intensity is found in the frequency range below 3 kHz. Reference 714 illustrates a faint first band from 4 kHz to 4.25 kHz. Reference 716 illustrates a stronger second band from 5.7 kHz to 6.3 kHz. Reference 718 illustrates a third band, stronger than the first band, from 7.3 kHz to 7.8 kHz.

FIG. 6M illustrates the spectrogram for a construction site heavy duty vacuum cleaner. A vacuum cleaner uses an electric motor-driven air pump to generate suction at the end of a hose, for removing dirt from surfaces. Reference 722 illustrates that low intensity is found in the frequency range below 1.8 kHz. Reference 724 illustrates a first band from 1.8 kHz to 2 kHz. Reference 726 illustrates a dispersed stronger band from 3 kHz to 8 kHz. Reference 728 illustrates a sub-band of band 726 from 3.8 kHz to 4.3 kHz. Reference 729 illustrates a sub-band of band 726 from 6.3 kHz to 7 kHz.

FIG. 6N illustrates the spectrogram for a drill press. A drill press is a power tool also known as a pedestal drill, pillar drill, or bench drill. The drill is mounted to a stand or workbench. A handle-driven mechanism enables the drill bit to be slid linearly back and forth to drill holes in materials. Reference 732 illustrates that low intensity is found in the frequency range below 3 kHz. Reference 734 illustrates a dispersed faint band from 4.5 kHz to 8 kHz. Reference 736 illustrates a sub-band of band 734 from 6 kHz to 6.5 kHz. Other fainter bands are visible at 3.4 kHz, 5.3 kHz, and 7.5 kHz.

FIG. 6O illustrates the spectrogram for a grinding wheel. A grinding wheel is a bench mounted device with one or more (usually two) carbide wheels spinning at high speed and generally used to remove rough surfaces from metal or to sharpen metal blades and drill bits etc. Reference 742 illustrates that low intensity is found in the frequency range below 7 kHz, and especially below 5.5 kHz. Reference 744 illustrates a band from 7 kHz to 8 kHz.

From the above spectrograms and summaries, it can be seen that several variables are capable of discriminating between different types of construction equipment 3:
number of simultaneous frequency bands (one, two, three, or more);
centre frequency of the/each band;
bandwidth of the/each band;
spectral intensity of the/each band; and/or
whether a band has one or more sub-bands.

The results of FIGS. 6A-6O show that the following tools have multiple simultaneous and pronounced frequency bands: angle grinder; table saw; jigsaw; router; battery drill; vacuum cleaner; drill press.

In each tested case, the key information for discriminating between types of construction equipment 3 could be found from the range 1.5 kHz to 8 kHz. The signal processor's filter may include this range in its passband.

Tables 3A-3B below illustrate a confusion matrix of the machine learning engine 210 when recorded samples were tested against the trained machine learning engine 210 that had been trained based on the data shown in FIGS. 6A-6O.

The testing was conducted via a single omnidirectional microphone 202 placed 1 metre away from the activity. F1 accuracy scores are shown in the last row (higher is better).

TABLE 3A

| % | I | II | III | IV | V | VI | VII | VIII |
|---|---|---|---|---|---|---|---|---|
| I: Angle grinder | 93.5 | 3.2 | 0 | 0 | 0 | 0 | 3.2 | 0 |
| II: Battery drill | 11.1 | 72.2 | 0 | 0 | 0 | 0 | 0 | 0 |
| III: Drill press | 0 | 0 | 93.3 | 0 | 0 | 0 | 6.7 | 0 |
| IV: Electric plane | 0 | 0 | 0 | 83.3 | 0 | 0 | 0 | 0 |
| V: Grinder | 0 | 0 | 0 | 0 | 80 | 0 | 0 | 0 |
| VI: Grinding wheel | 0 | 0 | 0 | 0 | 0 | 100 | 0 | 0 |
| VII: Hammer drill | 0 | 0 | 4 | 0 | 0 | 0 | 88 | 4 |
| VIII: Jigsaw | 6.9 | 3.4 | 0 | 0 | 3.4 | 0 | 6.9 | 48.3 |
| IX: Pad sander | 0 | 0 | 0 | 0 | 0 | 0 | 0 | 0 |
| X: Plasterboard screw gun | 0 | 0 | 0 | 0 | 0 | 0 | 0 | 6.3 |
| XI: Router | 1.2 | 0 | 0 | 0 | 0 | 0 | 0 | 0 |
| XII: Scaffold wrench | 0 | 0 | 0 | 0 | 0 | 20 | 0 | 0 |
| XIII: Steel saw | 0 | 0 | 0 | 0 | 0 | 0 | 0 | 0 |
| XIV: Table saw | 0 | 3 | 0 | 0 | 3 | 0 | 3 | 3 |
| XV: Talking | 0 | 0 | 3 | 0 | 0 | 0 | 0 | 0 |
| (not construction equipment) | | | | | | | | |
| XVI: Vacuum | 0 | 0 | 20 | 0 | 0 | 0 | 0 | 0 |
| F1 | 0.93 | 0.74 | 0.87 | 0.91 | 0.80 | 0.80 | 0.83 | 0.61 |

TABLE 3B

| % | IX | X | XI | XII | XIII | XIV | XV | XVI |
|---|---|---|---|---|---|---|---|---|
| I: Angle grinder | 0 | 0 | 0 | 0 | 0 | 0 | 0 | 0 |
| II: Battery drill | 0 | 0 | 0 | 5.6 | 0 | 5.6 | 0 | 5.6 |
| III: Drill press | 0 | 0 | 0 | 0 | 0 | 0 | 0 | 0 |
| IV: Electric plane | 0 | 0 | 0 | 0 | 0 | 16.7 | 0 | 0 |
| V: Grinder | 0 | 10 | 0 | 0 | 0 | 0 | 0 | 10 |
| VI: Grinding wheel | 0 | 0 | 0 | 0 | 0 | 0 | 0 | 0 |
| VII: Hammer drill | 0 | 0 | 0 | 0 | 0 | 4 | 0 | 0 |
| VIII: Jigsaw | 3.4 | 0 | 24.1 | 3.4 | 0 | 0 | 0 | 0 |
| IX: Pad sander | 85.7 | 0 | 3.6 | 0 | 3.6 | 7.1 | 0 | 0 |
| X: Plasterboard screw gun | 0 | 87.5 | 6.3 | 0 | 0 | 0 | 0 | 0 |
| XI: Router | 0 | 1.2 | 87.7 | 0 | 0 | 9.9 | 0 | 0 |
| XII: Scaffold wrench | 0 | 0 | 0 | 80 | 0 | 0 | 0 | 0 |
| XIII: Steel saw | 0 | 0 | 0 | 0 | 90 | 10 | 0 | 0 |
| XIV: Table saw | 0 | 3 | 0 | 9.1 | 0 | 75.8 | 0 | 0 |
| XV: Talking | 0 | 0 | 0 | 3 | 0 | 0 | 93.9 | 0 |
| (not construction equipment) | | | | | | | | |
| XVI: Vacuum | 0 | 0 | 0 | 0 | 0 | 0 | 0 | 80 |
| F1 | 0.91 | 0.85 | 0.88 | 0.53 | 0.90 | 0.69 | 0.97 | 0.73 |

The overall accuracy was 84.1% and the loss was 0.67. The worst performing tool was the jigsaw which was sometimes classified as a router. Investigation of the results found that this is because the jigsaw samples showed much variation as this tool can be operated at many different speeds with many different materials. This misclassification is surmountable with further training samples.

Another below-average tool was the scaffold wrench which was sometimes classified as a grinding wheel. This misclassification is surmountable with further training samples.

FIG. 4 illustrates an example of a controller 400 suitable for use in a system 100 or apparatus 102, 103. The controllers 106 and/or 206 may be implemented as a controller 400. Implementation of a controller 400 may be as controller circuitry. The controller 400 may be implemented in hardware alone, have certain aspects in software including firmware alone or can be a combination of hardware and software (including firmware).

As illustrated in FIG. 4 the controller 400 may be implemented using instructions that enable hardware functionality, for example, by using executable instructions of a computer program 408 in a general-purpose or special-purpose processor 404 that may be stored on a computer readable storage medium (disk, memory etc) to be executed by such a processor 404.

The processor 404 is configured to read from and write to the memory 406. The controller 400 may comprise an interface 402. The processor 404 may also comprise an output interface via which data and/or commands are output by the processor 404 and an input interface via which data and/or commands are input to the processor 404.

The memory 406 stores a computer program 408 comprising computer program instructions (computer program code) that controls the operation of the apparatus 102, 103 when loaded into the processor 404. The computer program instructions, of the computer program 408, provide the logic and routines that enables the apparatus to perform the methods 300 illustrated in the accompanying FIGs. The processor 404 by reading the memory 406 is able to load and execute the computer program 408.

The apparatus 102, 103 or system 100 comprises means for performing the method 300, the means being in the form of:
at least one processor 404; and
at least one memory 406 including computer program code,
the at least one memory 406 and the computer program code configured to, with the at least one processor 404, cause the apparatus 102, 103 at least to perform:
   receiving 302 audio information obtained by at least a first microphone 202 of a plurality of microphones 202 distributed around a construction site 1; and
   determining 308 a type of construction equipment 3 in-use based on the received audio information, via a machine learning engine 210.

The apparatus 102, 103 or system 100 comprises means for performing the method 300, the means being in the form of:
at least one processor 404; and
   at least one memory 406 including computer program code,
   the at least one memory storing instructions that, when executed by the at least one processor 404, cause the apparatus at least to:
   receive 302 audio information obtained by at least a first microphone 202 of a plurality of microphones 202 distributed around a construction site 1; and
   determine 308 a type of construction equipment 3 in-use based on the received audio information, via a machine learning engine 210.

As illustrated in FIG. 5, the computer program 408 may arrive at the apparatus 102, 103 via any suitable delivery mechanism 500. The delivery mechanism 500 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 408. The delivery mechanism may be a signal configured to reliably transfer the computer program 408. The apparatus 102, 103 may propagate or transmit the computer program 408 as a computer data signal.

Computer program instructions for causing an apparatus to perform at least the following or for performing at least the following:
receiving 302 audio information obtained by at least a first microphone 202 of a plurality of microphones 202 distributed around a construction site 1; and
determining 308 a type of construction equipment 3 in-use based on the received audio information, via a machine learning engine 210.

The computer program instructions may be comprised in a computer program, a non-transitory computer readable medium, a computer program product, a machine readable medium. In some but not necessarily all examples, the computer program instructions may be distributed over more than one computer program.

Although the memory 406 is illustrated as a single component/circuitry it may be implemented as one or more separate components/circuitry some or all of which may be integrated/removable and/or may provide permanent/semi-permanent/dynamic/cached storage.

Although the processor 404 is illustrated as a single component/circuitry it may be implemented as one or more separate components/circuitry some or all of which may be integrated/removable. The processor 404 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialised circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The blocks illustrated in the accompanying FIGs may represent steps in a method 300 and/or sections of code in the computer program 408. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

The systems, apparatus, methods and computer programs may use machine learning which can include statistical learning. Machine learning is a field of computer science that gives computers the ability to learn without being explicitly programmed. The computer learns from experience E with respect to some class of tasks T and performance measures P if its performance at tasks in T, as measured by P, improves with experience E. The computer can often learn from prior training data to make predictions on future data. Machine learning includes wholly or partially supervised learning and wholly or partially unsupervised learning. It may enable discrete outputs (for example classification, clustering) and continuous outputs (for example regression). Machine learning may for example be implemented using different approaches such as cost function minimization, artificial neural networks, support vector machines and Bayesian networks for example. Cost function minimization may, for example, be used in linear and polynomial regression and K-means clustering. Artificial neural networks, for example with one or more hidden layers, model complex relationships between input vectors and output vectors. Support vector machines may be used for supervised learning. A Bayesian network is a directed acyclic graph that represents the conditional independence of a number of random variables.

The algorithms hereinbefore described may be applied to achieve the following technical effects: an improved sensor system; a more accurate sensor system; a lower-power sensor system; an improved edge computing sensor system; a more secure sensor system; an improved alerting system for construction sites.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like.

Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims. For example, the edge computing system described above may be replaced with a non-edge computing system where the construction equipment 3 is determined by a server controller 103, 106.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasise an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavouring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. A system comprising microphones distributed around a construction site, the system further comprising at least one processor; and at least one memory including computer program code, the at least one memory and the computer program code configured to, with the at least one processor, cause the system at least to perform:
receiving audio information obtained by at least a first microphone of the microphones; and
determining a type of construction equipment in-use based on the received audio information, via a machine learning engine.

2. The system of claim 1, wherein the microphones comprise omnidirectional microphones.

3. The system of claim 1, wherein the system comprises devices distributed around the construction site, each device comprising a different one of the microphones.

4. The system of claim 3, wherein each device is an edge device comprising one of the at least one memory and the computer program code, configured to, with the at least one processor, cause the edge device to perform determining the type of construction equipment in-use, the computer program code of the edge device including a trained copy of the machine learning engine.

5. The system of claim 3, wherein each device comprises a battery and each trained copy of the machine learning engine represents weights and activations with a precision less than 32 bits, or less than 16 bits.

6. The system of claim 3, wherein each device comprises a securing point enabling attachment of the device to a support.

7. The system of claim 3, wherein the at least one memory and the computer program code are configured to, with the at least one processor, further cause the system at least to perform:
obtaining information indicating a location of a first device of the devices, the first device comprising the first microphone; and
associating the determined type of construction equipment in-use with the information indicating the location of the first device.

8. The system of claim 7, wherein the at least one memory and the computer program code are configured to, with the at least one processor, further cause the system at least to perform causing, at least in part, outputting of an alert in dependence on the determined type of construction equipment in-use and on the information indicating the location of the first device.

9. The system of claim 1, wherein the at least one memory and the computer program code are configured to, with the at least one processor, further cause the system at least to perform: filtering the audio information based on an intensity of the audio information, and determining the type of construction equipment in-use based on the filtered audio information.

10. The system of claim 1, wherein the at least one memory and the computer program code are configured to, with the at least one processor, further cause the system at least to perform: generating samples of the audio information, the samples having a duration selected from the range 0.5 seconds to five seconds, and wherein determining the type of construction equipment in-use comprises processing at least one of the samples via the machine learning engine.

11. The system of claim 1, wherein determining the type of construction equipment in-use via the machine learning engine is dependent on a first above-threshold frequency and on whether the audio information contains one or more further above-threshold frequencies which are simultaneous with the first frequency over a period of time.

12. The system of claim 1, wherein the determination of a type of construction equipment in-use is dependent on frequency content from the range 1.5 kHz to 8 kHz.

13. The system of claim 1, wherein the determination of a type of construction equipment in-use is based on two or more of the following variables:
whether the audio information contains two simultaneous frequency bands;
whether the audio information contains three simultaneous frequency bands;
a centre frequency of at least one frequency band;
a bandwidth of at least one frequency band; or
an intensity of at least part of the audio information.

14. The system of claim 13, wherein the machine learning engine is trained to recognise, based on the two or more of the variables, at least two of the following types of construction equipment:
angle grinder;
saw;
router;
drill;
vacuum cleaner;
scaffold wrench;
screw gun;
pad sander;
grinder;
electric plane; or
grinding wheel.

15. The system of claim 1, further comprising human presence detectors distributed around the construction site, wherein the at least one memory and the computer program code are configured to, with the at least one processor, further cause the system at least to perform: causing, at least in part, outputting of an alert in dependence on the determined type of construction equipment in-use, and on information from the human presence detectors indicating an above-threshold number of humans proximal to the first microphone.

16. The system of claim 1, wherein the at least one memory and the computer program code are configured to, with the at least one processor, further cause the system at least to perform: causing, at least in part, outputting of an alert in dependence on the determined type of construction equipment in-use and on time of day.

17. The system of claim 1, wherein the at least one memory and the computer program code are configured to, with the at least one processor, further cause the system at least to perform: causing, at least in part, outputting of an alert in dependence on the determined type of construction equipment in-use and on a noise threshold.

18. The system of claim 1, wherein the at least one memory and the computer program code are configured to, with the at least one processor, further cause the system at least to perform: causing, at least in part, outputting of an alert in dependence on the determined type of construction equipment in-use.

19. A method comprising:
receiving audio information obtained by at least a first microphone of a plurality of microphones distributed around a construction site; and
determining a type of construction equipment in-use based on the received audio information, via a machine learning engine.

20. An apparatus comprising at least one processor; and at least one memory including computer program code, the at least one memory and the computer program code configured to, with the at least one processor, cause the apparatus at least to perform:
receiving audio information obtained by at least a first microphone of a plurality of microphones distributed around a construction site; and
determining a type of construction equipment in-use based on the received audio information, via a machine learning engine.
